(19) United States
(12) Patent Application Publication
(10) Pub. No.: US 2026/0328586 A1
(43) Pub. Date: Oct. 22, 2026

(54) FAIL-OPERATIONAL COGNITIVE NAVIGATOR FOR THE VISUALLY IMPAIRED

(71) Applicant: Richard Joseph Mitchell, TAVARES, FL (US)

(72) Inventor: Richard Joseph Mitchell, TAVARES, FL (US)

(21) Appl. No.: 19/376,991

(22) Filed: Nov. 2, 2025

(51) Int. Cl. G01C 21/00; A61H 3/06

(52) U.S. Cl. CPC G01C 21/3848; A61H 3/061; A61H 2201/165; A61H 2201/5092

(57) ABSTRACT

A wearable navigation device and method for assisting a visually impaired user addresses the technical problem of ensuring trustworthiness and continuous operation in assistive aids. The device includes a multi-modal sensor suite with at least a LiDAR sensor, a thermal camera, and an RGB camera to generate a robust environmental map under diverse conditions. A fail-operational reliability architecture, including a redundant pair of processors, is configured to mitigate safety risks arising from system faults. In the event of a primary processor fault, detected via a heartbeat signal, the architecture seamlessly transitions control of essential navigation functions to a secondary processor, ensuring continuous and safe operation. The system may further include a prognostic health management subsystem utilizing an LSTM neural network to predict impending failures and a cross-modal geometric validation algorithm to improve object detection accuracy by validating camera-based hypotheses against LiDAR point cloud data.

### BACKGROUND OF THE INVENTION

### 1. Technical Field

The present invention relates generally to the field of electronic assistive devices. More specifically, it pertains to wearable, computer-vision-based navigation systems configured to provide real-time environmental interpretation and guidance for visually impaired individuals.

### 2. Background Art

Electronic assistive devices for the visually impaired have evolved from simple sensory-substitution tools to complex computational systems. Early devices focused on singular tasks, such as detecting nearby objects using ultrasonic range finders. More recent advancements have incorporated cameras and computer vision algorithms to perform tasks like text reading or facial recognition. For example, U.S. Pat. No. 10,900,788B2 , issued to Kumar, describes a wearable navigation system that utilizes a camera and orientation sensors to provide guidance.

However, the trajectory of innovation in this field has revealed a fundamental technical challenge that the prior art has failed to address. The primary focus of existing systems has been on solving the problem of insufficient perception. Prior art devices typically rely on a limited suite of sensors, such as a single RGB camera or a basic range finder. This limited sensory input results in an incomplete and often unreliable digital model of the user's environment, making such systems highly susceptible to failure in adverse conditions, including low light, darkness, or through obscurants like fog and rain.

Incorporating more advanced sensor suites (e.g., LiDAR, thermal cameras) from analogous arts like autonomous vehicles the problem of insufficient perception. However, in doing so, this path of development gives rise to a new, more subtle, and previously unrecognized technical problem: the problem of trustworthiness in a safety-critical system.

As these assistive devices become more computationally powerful and provide a high-fidelity model of the world, a user's dependency on the device increases to the point where the device becomes a primary sensory input for ensuring physical safety. The user is asked to place their complete trust in the system's output. This elevation in capability transforms the device from a mere convenience into a safety-critical system. Yet, the architectural philosophy of the prior art is fundamentally unsuited for this new reality.

Existing systems are universally designed to be “fail-safe,” meaning that upon detection of a critical hardware or software error, the system's primary response is to shut down or cease providing guidance. This approach, while common in consumer electronics, is critically flawed in this context. A fail-safe shutdown abruptly abandons the user, who may be mid-stride in a complex environment like a busy intersection, leaving them disoriented and in a potentially more dangerous situation than if they had no device at all.

The prior art has thus focused on the problem of providing navigational information but has failed to recognize the critical, second-order technical problem that arises from its own solution: ensuring the continuous availability and trustworthiness of that information when a user's safety is entirely dependent on it. There remains a need for a navigation aid that is architected from the ground up to solve this problem, providing a system that not only perceives the environment with high fidelity but also maintains essential functionality even in the face of component failure.

### BRIEF SUMMARY OF THE INVENTION

The present invention is directed to a system and method that overcomes the foregoing deficiencies in the prior art by providing a synergistic system architecture that solves the dual problems of insufficient perception and inadequate reliability. The invention, referred to herein as the Cognitive Navigator, is a wearable device comprising an integrated system of three interdependent technological pillars: an Advanced Multi-Modal Perception Suite, an Artificial Intelligence (AI) Interpretation Core, and a Fail-Operational Reliability Architecture.

The inventive concept lies in the recognition of, and solution to, the technical problem of trustworthiness that arises directly from the creation of a high-fidelity perception system. The synergistic integration of the invention's components provides a technical solution that is greater than the sum of its parts. The rich, multi-modal data stream from the perception suite enables the AI core to generate a semantic understanding of the environment. The Fail-Operational Reliability Architecture is the specific, technical solution to the problem of ensuring the trustworthiness of the information stream when a user's safety is at stake, making the pillars of the invention deeply and functionally interdependent.

The invention is not an abstract idea of collecting and analyzing data, but rather a specific improvement to the functionality of a computer system, resulting in a new class of safety-critical, human-computer interface. It is a tangible machine that solves the specific technical problem of ensuring reliable, continuous navigation for the visually impaired with a specific and unconventional technical solution.

In one aspect, a wearable navigation device is provided. The device comprises a multi-modal sensor suite configured to generate a semantic map of an environment. The device further comprises a fail-operational reliability architecture, including a primary processor and a secondary processor, configured to mitigate a safety risk by seamlessly transitioning control of essential navigation functions from the primary processor to the secondary processor in response to a fault.

In another aspect, a method for providing fail-operational navigation to a visually impaired user is provided. The method includes generating, via a multi-modal sensor suite, a semantic map of an environment. The method further involves operating a primary processor to determine a navigable path based on the map and provide guidance to the user. In response to detecting a fault associated with the primary processor, the method includes mitigating a safety risk by seamlessly transitioning control of determining the navigable path and providing guidance to a secondary processor, thereby ensuring substantially uninterrupted navigation.

### BRIEF DESCRIPTION OF THE SEVERAL VIEWS OF THE DRAWING

The accompanying drawings, which are incorporated in and constitute a part of this specification, illustrate embodiments of the invention and, together with the description, serve to explain the principles of the invention.

FIG. 1 is a perspective view of a user wearing an exemplary embodiment of the Cognitive Navigator device.

FIG. 2 is a system-level block diagram of the Cognitive Navigator, illustrating the interconnections between the multi-modal sensor suite, the redundant control module, memory, power management subsystem, and user feedback interfaces.

FIG. 3 is a detailed schematic of the Advanced Multi-Modal Perception Suite, showing the physical arrangement and data links of the LiDAR sensor, thermal camera, RGB cameras, and Inertial Measurement Unit (IMU).

FIG. 4 is a block diagram of the Fail-Operational Reliability Architecture, detailing the dual-processor configuration, the health monitoring unit, and the failover control logic.

FIG. 5 is a data flow diagram illustrating the process of the AI Interpretation Core, from raw multi-modal data streams through sensor fusion to semantic segmentation and pathfinding.

FIG. 6 is a flowchart illustrating the logical steps of the Cross-Modal Geometric Validation process.

FIG. 7 is a flowchart illustrating the method of the Prognostic Health Management (PHM) subsystem.

### DETAILED DESCRIPTION OF THE INVENTION

### I. System Architecture and Principle of Operation

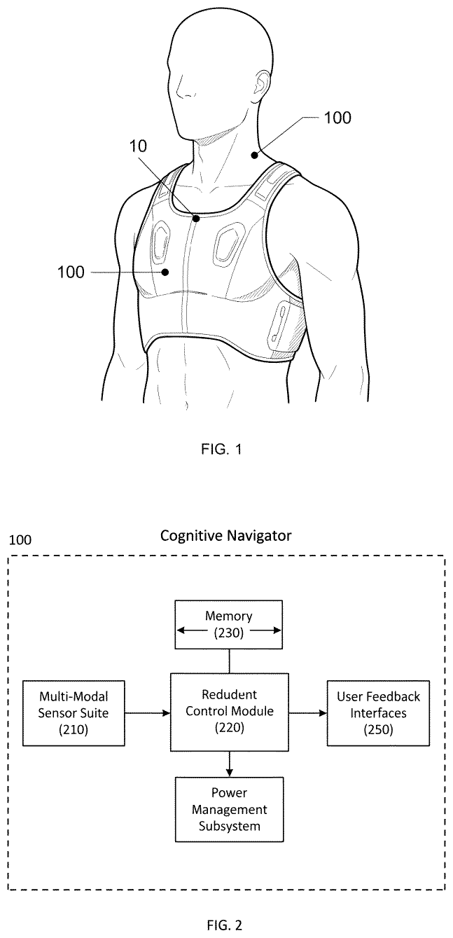

Referring to FIG. 1 and FIG. 2, an exemplary embodiment of the Cognitive Navigator system is shown. The device (100) may be embodied in a wearable form factor, such as a vest, harness, or head-mounted unit, worn by a user 10. The device (100) comprises a housing that contains the core electronic components, including a multi-modal sensor suite (210), a redundant control module (220), memory (230), a power management subsystem (240), and user feedback interfaces (250).

The principle of operation is based on the synergistic function of three technological pillars. First, the Advanced Multi-Modal Perception Suite (210) captures a comprehensive, 360-degree model of the user's environment. Second, the AI Interpretation Core, executed by the redundant control module (220), processes this rich data stream to create a high-level, semantic understanding of the environment and generate actionable navigation commands. Third, the Fail-Operational Reliability Architecture, embodied in the redundant control module (220) and associated logic, directly addresses the technical problem of user dependency by providing a level of trustworthiness previously unseen in assistive technology, ensuring the system maintains continuous, safe operation even in the event of a component failure.

### II. The Advanced Multi-Modal Perception Suite

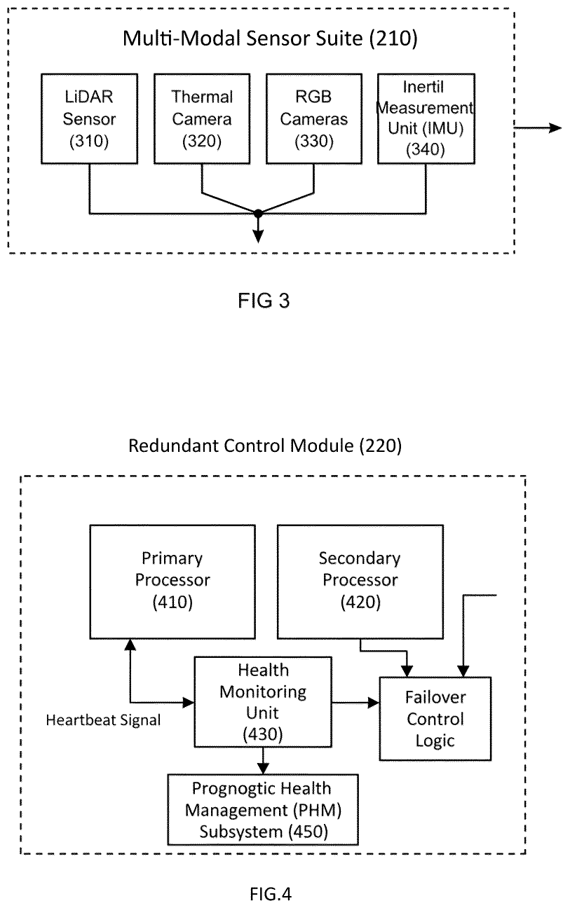

As illustrated in FIG. 3, the Advanced Multi-Modal Perception Suite (210) is an integrated array of sensors designed to provide a robust environmental model under diverse conditions, far surpassing the capabilities of prior art systems.

### Component Technologies

The suite (210) includes a combination of sensor modalities. A LiDAR (Light Detection and Ranging) sensor (310) provides highly accurate 3D point cloud data for precise distance measurement and geometric mapping. A thermal or infrared camera (320) detects heat signatures, allowing the system to identify living beings and running engines in darkness or through obscurants. One or more RGB cameras (330) capture rich visual data, including color and texture, for tasks such as reading text on signs. An Inertial Measurement Unit (IMU) (340) tracks the user's motion and orientation to stabilize sensor inputs.

### Multi-modal Sensor Fusion

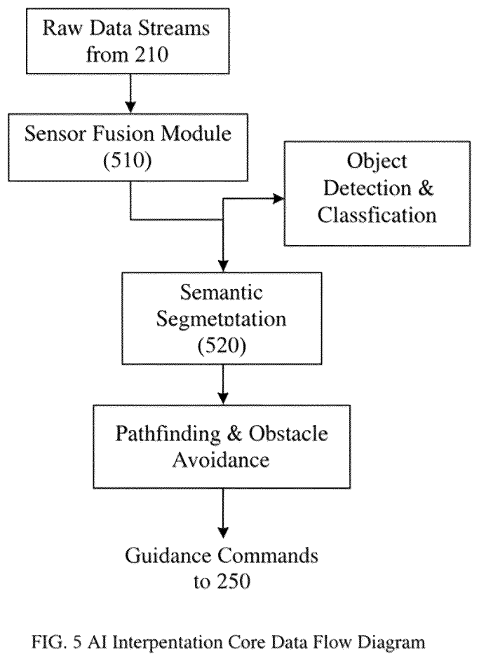

As shown in FIG. 5, raw data streams from the various sensors are processed by a sensor fusion module (510). This module integrates the disparate data sources to produce a model that is more accurate and reliable than any single sensor alone. For example, the system may overlay thermal data from the thermal camera (320) onto a 3D LiDAR point cloud from the LiDAR sensor (310) to confirm that a detected obstacle is a person. this fusion can be accomplished using techniques such as extended Kalman filters or deep learning models like transformer-based neural networks that learn to weigh and combine feature representations from different modalities.

### III. The AI Interpretation Core

The AI Interpretation Core is executed on the redundant control module (220) and transforms the fused, multi-modal data stream into a high-level, semantic understanding of the environment.

### Real-Time Semantic Understanding

Referring to FIG. 5, the AI core performs several key functions. A semantic segmentation model (520) assigns a class label (e.g., sidewalk, road) to every point or pixel in the fused sensor data. An object detection and classification model (530) identifies discrete objects such as pedestrians and cars. Finally, a pathfinding and obstacle avoidance algorithm (540) analyzes the semantic map to identify safe, navigable pathways and generate step-by-step guidance.

### Cross-modal Geometric Validation

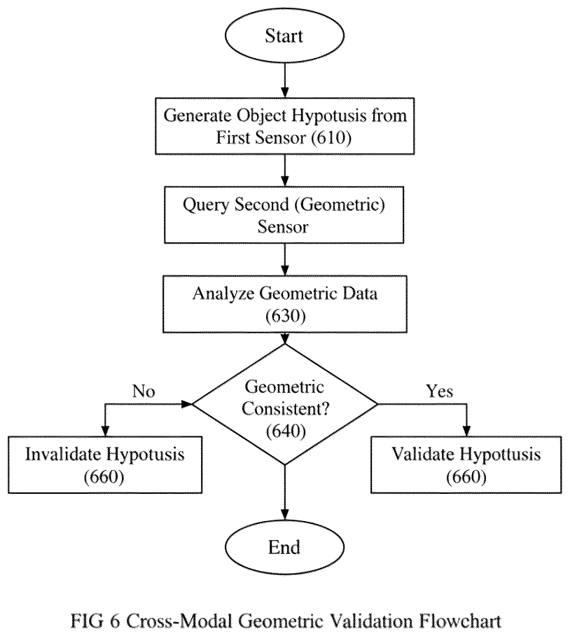

A novel aspect of the AI core is a process of Cross-Modal Geometric Validation (FIG. 6), which serves as an internal self-correction mechanism. The process begins (610) where an object hypothesis is generated from a first sensor modality (e.g., an RGB camera identifying a “doorway”). The system then queries (620) a second, geometrically precise sensor modality, such as the LiDAR sensor (310). The system analyzes the LiDAR data (630) to determine if it contains a geometric feature consistent with the hypothesis (e.g., an opening in a wall). If confirmed (640), the hypothesis is validated (650). If the LiDAR data shows a solid surface, the hypothesis is invalidated (660), preventing a hazardous navigation instruction.

### Enablement of the AI Interpretation Core

To enable a person of ordinary skill in the art to make and use the AI Interpretation Core without undue experimentation, the following implementation details are provided. The semantic segmentation (520) and object detection (530) modules may be implemented using a transformer-based neural network architecture, such as a Vision Transformer (ViT) backbone modified for multi-modal inputs. The network would be trained on a large-scale, annotated dataset comprising synchronized LiDAR point clouds, thermal images, and RGB video streams captured from diverse pedestrian environments and weather conditions. Annotations would include pixel-level semantic labels and 3D bounding boxes for all relevant object classes. The Cross-Modal Geometric Validation process (FIG. 6) would be implemented algorithmically by projecting the 2D bounding box of a camera-detected object hypothesis into the 3D space of the LiDAR point cloud. The algorithm would then analyze the density and geometric continuity of points within that 3D volume to confirm the presence of a corresponding physical object, distinguishing it from false positives like posters or reflections. To meet the real-time processing constraints of a wearable device, the trained neural network models would be optimized via techniques such as 8-bit quantization and deployed on a low-power embedded AI accelerator (e.g., a GPU or TPU) within the redundant control module (220).

### IV. The Fail-Operational Reliability Architecture

The most significant inventive aspect of the Cognitive Navigator is its Fail-Operational Reliability Architecture, which addresses the safety-critical condition created by user dependency. As shown in FIG. 4, this architecture maintains essential functionality after a component failure, in stark contrast to the fail-safe approach of the prior art.

### Redundant Control Systems

The core of the architecture is the redundant control module (220), comprising a primary processor (410) and a secondary processor (420). In normal operation, the primary processor (410) executes the main navigation tasks. A health monitoring unit (430), which can be implemented on the secondary processor (420), constantly monitors the status of the primary processor (410) via a “heartbeat” signal. Upon detection of a fault, a failover control logic (440) seamlessly transfers control of all essential navigation functions to the secondary processor (420). This application of dual modular redundancy, a concept known in safety-critical aerospace and automotive systems (see, e.g., U.S. Pat. No. 10,442,459 to Siskoy et al.) is a novel and non-obvious application to a wearable assistive device to solve the specific problem of dependency-induced safety risk.

### Prognostic Health Management (PHM)

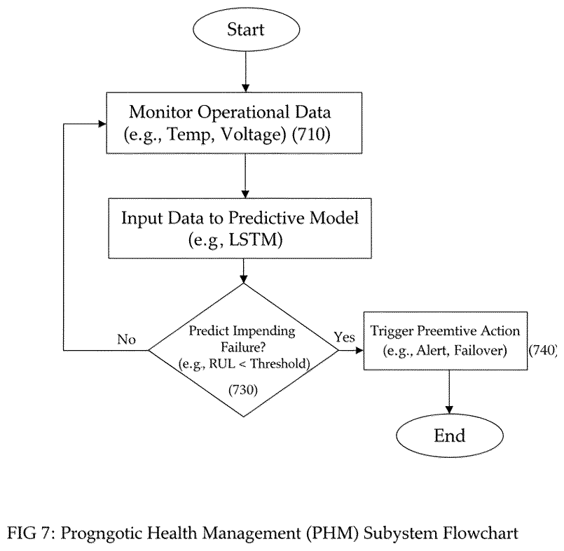

As detailed in FIG. 7, the system further incorporates a Prognostic Health Management (PHM) subsystem (450). This AI-driven subsystem monitors (710) operational data, such as battery voltage and processor temperatures. this data is fed into a predictive model (720) that analyzes trends to predict impending failures (730). For example, the predictive model may comprise a Long Short-Term Memory (LSTM) neural network trained to analyze time-series data of battery discharge curves and processor thermal cycling to calculate a Remaining Useful Life (RUL) for those components. If a failure is predicted (e.g., RUL falls below a predetermined threshold), it can trigger a preemptive action (740), such as alerting the user or initiating a graceful degradation of non-essential functions.

### V. User Feedback Interfaces and Continuous Guidance

The user feedback interfaces (250) are designed for continuous operation under the Fail-Operational Reliability Architecture. The output from the pathfinding algorithm (540) is translated into non-visual commands via these interfaces, which may include a bone-conduction audio transducer and haptic actuators. the failover control logic (440) ensures that in the event of primary processor failure, the secondary processor (420) takes immediate, seamless control of these interfaces, thereby maintaining continuous, reliable, and non-visual feedback to the user.

What is claimed is:

1. A wearable navigation device for a visually impaired user, the device comprising:
a. a multi-modal sensor suite coupled to a housing configured to be worn by the user, the sensor suite comprising at least a LiDAR sensor, a thermal camera, and an RGB camera;
b. a user feedback interface comprising at least one of a bone-conduction audio transducer or a haptic actuator; and
c. a fail-operational reliability architecture disposed within the housing, the architecture comprising a primary processor and a secondary processor, wherein at least one of the processors is configured to:
i. generate a semantic map of an environment by fusing 3D point cloud data the LiDAR sensor, thermal data from the thermal camera, and image data from the RGB camera;
ii. determine a navigable path based on the semantic map; and
iii. provide guidance to the user corresponding to the navigable path via the user feedback interface;
d. wherein the fail-operational reliability architecture is further configured to:
i. monitor an operational status of the primary processor via a heartbeat signal;
ii. detect a fault associated with the primary processor; and
iii. in response to detecting the fault, seamlessly transition control of determining the navigable path and providing guidance from the primary processor to the secondary processor, thereby providing substantially uninterrupted guidance to the user.

2. The device of claim 1, wherein the multi-modal sensor suite further comprises an Inertial Measurement Unit (IMU) configured to provide orientation data to stabilize data from the other sensors.

3. The device of claim 1, further comprising a non-transitory computer-readable medium storing instructions that, when executed by at least one of the processors, cause the device to perform a cross-modal geometric validation by:
a. generating an object hypothesis and a corresponding 2D bounding box based on image data from the RGB camera;
b. projecting the 2D bounding box into a 3D point cloud from the LiDAR sensor to define a 3D validation volume;
c. analyzing a point density of LiDAR points within the 3D validation volume; and
d. invalidating the object hypothesis if the point density is below a predetermined threshold, thereby preventing a navigation instruction based on a false positive object detection.

4. The device of claim 1, wherein the fault is an impending failure predicted by a prognostic health management (PHM) subsystem.

5. The device of claim 4, wherein the PHM subsystem is configured to predict the impending failure by:
a. monitoring a time-series of operational data, wherein the operational data includes at least one of a battery discharge curve a processor temperature;
b. inputting said time-series of operational data into a trained predictive model comprising a Long Short-Term Memory (LSTM) neural network; and
c. calculating a Remaining Useful Life (RUL) for a component based on an output of the LSTM neural network, wherein the impending failure is predicted when the RUL is below a predetermined threshold.

6. The device of claim, wherein in response to predicting the impending failure, the fail-operational reliability architecture is further configured to transition the device into a graceful degradation mode wherein non-essential functions are deactivated to preserve the set of essential navigation functions.

7. The device of claim 1, at least one processor is configured to generate the semantic map using a trained Vision Transformer (ViT) neural network architecture modified for multi-modal inputs from the LiDAR sensor, the thermal camera, and the RGB camera.

8. A method for providing fail-operational navigation to a visually impaired user via a wearable device having a primary processor, a secondary processor, and a multi-modal sensor suite comprising at least a LiDAR sensor, a thermal camera, and an RGB camera, the method comprising:
a. generating, via the multi-modal sensor suite, a semantic map of an environment by fusing 3D point cloud data from LiDAR sensor, thermal data from the thermal camera, and image data from the RGB camera;
b. operating the primary processor to execute a set of essential navigation functions, the essential navigation functions including determining a navigable path based on the semantic map and providing guidance to the user corresponding to the navigable path;
c. monitoring, via the secondary processor, a heartbeat signal transmitted by the primary processor to determine an operational status of the primary processor;
d. detecting a fault associated with the primary processor based on the monitoring; and
e. in response to detecting the fault, seamlessly transitioning control of the set of essential navigation functions from the primary processor to the secondary processor, thereby ensuring the guidance provided to the user is substantially uninterrupted.

9. The method of claim, wherein generating the semantic map comprises performing a cross-modal geometric validation to verify an object identified in the map, the cross-modal geometric validation comprising:
a. generating an object hypothesis and a corresponding 2D bounding box based on image data from the RGB camera;
b. projecting the 2D bounding box into a 3D point cloud from the LiDAR sensor to define a 3D validation volume;
c. calculating a point density of LiDAR points within the 3D validation volume; and
d. invalidating the object hypothesis if the point density is below a predetermined threshold.

10. The method of claim 8, wherein detecting the fault comprises predicting an impending component failure within the wearable device by:
a. monitoring a time-series of operational data of the wearable device, the operational data including at least one a battery discharge curve or a processor temperature;
b. analyzing said time-series of operational data using a trained Long Short-Term Memory (LSTM) neural network to calculate a Remaining Useful Life (RUL) for a component; and
c. identifying the impending component failure when the RUL falls below a predetermined threshold.

11. The method of claim 10, further comprising:
a. in response to predicting the impending component failure, transitioning the wearable device into a graceful degradation mode wherein non-essential functions are deactivated to preserve the set of essential navigation functions.

12. The method of claim, wherein generating semantic map is performed using a trained Vision Transformer (ViT) neural network architecture configured to process the fused data from the multi-modal sensor suite.
